(19) United States
(12) Patent Application Publication
(10) Pub. No.: US 2024/0238736 A1
(43) Pub. Date: Jul. 18, 2024

(54) ION EXCHANGE MEMBRANE AND METHODS OF RECOVERING A TARGET ION

(71) Applicant: Summit Nanotech Corporation, Calgary (CA)

(72) Inventors: Vijay Daga, North Hollywood, CA (US); Eric D. Nyberg, San Carlos, CA (US); Kelly Krahulic, Calgary (CA); Rick Schoephoerster, Palm Desert, CA (US); Stephen L. Tondre, Fremont, CA (US); Norman Wong, Calgary (CA)

(73) Assignee: Summit Nanotech Corporation, Calgary, AB (CA)

(21) Appl. No.: 18/560,058

(22) PCT Filed: May 11, 2022
(86) PCT No.: PCT/CA2022/050742

§ 371 Date: Nov. 9, 2023

Related U.S. Application Data
(60) Provisional application No. 63/187,761, filed on May 12, 2021.

(51) Int. Cl. B01D 69/14; B01D 61/44; B01D 61/46; B01D 69/02; B01D 69/12

(52) U.S. Cl. CPC B01D 69/147; B01D 61/445; B01D 61/463; B01D 61/464; B01D 69/02; B01D 69/1216; B01D 69/148; B01D 2325/42

(57) ABSTRACT

The present disclosure relates to a membrane apparatus for selectively retaining and releasing target cations, such as lithium. The membrane apparatus comprises a cation exchange layer and an anion exchange layer that are coupled and configured for hydraulic communication with sufficient permselectivity to facilitate water splitting under an applied voltage. The cation exchange layer comprises a sorbing agent that has a target cation binding coefficient that is less than its hydrogen ion binding coefficient such that it may be efficiently regenerated by in situ produced hydrogen ions. Electrically regenerated ion exchange devices and methods are also described.

### CROSS-REFERENCE TO RELATED APPLICATIONS

This application claims the benefit of the filing of U.S. Provisional Patent Application No. 63/187,761, entitled “Bipolar Membrane Article and Electrochemical Device for Selective Chemical Recovery”, filed on May 12, 2021, and the specification and claims thereof are incorporated herein by reference.

### TECHNICAL FIELD

The present disclosure relates to the field of ion exchange. More particularly, the present disclosure relates to bipolar membranes, electrically regenerated ion exchange devices, and methods of recovering target ions from feed solutions.

### BACKGROUND

Electrochemical devices for practicing the batch ion exchange process using electricity and bipolar ion exchange membranes are known in the art. Inorganic materials have been used in ion exchange operations, for example in large vertical cylinders or columns, for the selective absorption of specific, or target, ions. For example, one may need to recover lithium ions from concentrated salt solutions, referred to here as feed solutions, comprising other salts such as sodium, potassium, calcium, and magnesium. Inorganic materials, typically but not exclusively inorganic oxides or metal oxides, have been utilized industrially, particularly as selective adsorbents (e.g. zeolites). Of particular interest are the spinel minerals, which have a general formula of AB₂X₄ (where, in a prototypical form, A and B are di- and trivalent respectively and X is anionic, usually O). These have demonstrated high selectivity and capacity for lithium over other alkali, alkali earth or transition metals that may be present in feed solutions. For example, hydrous metal oxides such as H₂TiO₃ have been shown to be efficient absorbers of lithium ions. More specifically, hydrous metal oxides with crystalline structures wherein the target lithium ions have been topotactically replaced with H⁺ or OH⁻ ions have been shown to be efficient absorbers of lithium ions. These structures are said to have “memory” for the lithium ion and allow for more selective absorption from feed solutions. Similarly, layered double hydroxide materials that have intercalated lithium ions replaced may also be suitable materials. Additionally, various types of LiMFePO₄ compounds (where M is Mn, Ti or Co) may also selectively absorb cations ions from feed solutions.

Absorption of cations by inorganic materials, for example metatitanate (MTA; H₂TiO₃), involves the addition of at least an equivalent of hydroxide (MOH, where M is typically an alkali metal ion) to deprotonate the titanate and create a binding site for the target ion, for example lithium. Without the reaction with hydroxide, which has a very high binding force with hydrogen ion, the lithium in this example cannot displace the hydrogen ion from the MTA. A related and more widely reported lithium selective compound, the spinel HₓMn₂₋ₓO₄ (where 0<x<0.33), also involves the addition of base to release H⁺ and allow for lithium ion absorption to occur.

The conventional method of regenerating the inorganic material to, for example, recover a selectively bound target ion, is elution with acidic or basic solution, for example, hydrochloric acid (HCl) or sulfuric acid (H₂SO₄). When using MTA for the selective absorption of lithium ion, for example, hydrogen ion (H⁺) replaces lithium ion in the MTA to form an effluent solution comprising a higher ratio of lithium ion compared to the other ions in the feed solution. The disadvantage of this method of recovering specific ions in this conventional process is the need for hazardous chemicals, concentrated acid or base solutions, and the contamination of the target ion(s) by the acid or base eluent. These hazardous chemicals are highly undesirable due to the cost and environmental impact of purchasing, shipping, storing, handling, and disposing of them in a safe and responsible manner.

Wide-ranging pH stability is a desirable property of bipolar ion exchange membranes. During their operation, cation exchange layers are exposed to pH values as low as 0, and anion exchange layers are exposed to pH values as high as 14 (e.g. during conversion of salts to acids and bases). The pH value range experienced by membranes in electrically regenerated ion exchange devices may be even wider, because these devices frequently cycle between deionization and regeneration—exposing both cation and anion exchange layers to pH value ranges of up to 0 to 14. To obtain the necessary pH stability, commercial ion exchange materials having the necessary properties and useful for electrically regenerated ion exchange devices are often prepared with cross-linked polyethylene backbones from, for example, the polymerization of acrylic acid or vinyl benzyl chloride. A variety of molecular groups can subsequently be affixed to these organic backbone structures to provide a range of properties (for example, ion exchange capacity, selectivity, stability over a wide range of pH, water absorption, physical strength, and thermal stability). While ion exchange materials having selectivity for transition metals (e.g., copper or chromium) compared to alkali metals (e.g., lithium and sodium) and alkali earth metals (e.g., magnesium and calcium), are available, for example ion exchange resins with carboxylic acid or aminodiacetic acid groups, there are no organic backbone ion exchange materials having the necessary properties for electrically regenerated ion exchange devices that are substantially selective for one alkali metal over others. Furthermore, the selectivity offered by organic ion exchange materials are generally in favor of ions with smaller hydrated diameters and higher charge density (i.e. Ba²⁺ will be adsorbed at a greater extent relative to Mg²⁺). The opposite selectivity would be favorable for the electrically regenerated ion exchange devices outlined herein to selectively remove lithium and generate a pure stream on release. Lithium ions have the lowest binding force with traditional organic ion exchange materials, weak acid (e.g., carboxylic acid group) and strong acid (e.g., sulfonate group) resins, due to lithium's hydrated diameter being larger than that of other alkali metals (hydrated diameter is inversely proportional to the alkali metal atomic weight).

Inorganic materials, for example metal oxides, can be susceptible to degradation at either low or high pH, for example as low as 0 and as high as 14. Generally speaking, the lower the metal ion valency the more soluble is the oxide. MTA is quite stable, perhaps due to the strength of the Ti—O bond, whereas in HMn₂O₄ the Mn—O bond is Jahn Teller distorted and weaker, and HMn₂O₄ tends to dissolve over time in basic solution. At HCl concentrations greater than 0.2 M, MTA reacts irreversibly to lose titanium.

Additionally, the permselectivity of many metal oxide materials is suspect, rendering them poor choices for use in electrically regenerated ion exchange devices. Low permselectivity enables current to be carried across the anion exchange-cation exchange layer boundary by direct migration of anions or cations, and thus with less, or in the extreme, no water-splitting reaction potential. At best, the result is an electrically regenerated ion exchange device which consumes more power per unit of product recovered and, at worst, there is no recovery capability at all.

The application of batch operated electrically regenerated ion exchange devices has been limited in practice to lower feed solution concentrations for two reasons. First, if the objective is the general reduction of solution conductivity, for example to prepare water for drinking or industrial processes, then when using feed solutions greater than about 5,000 ppm the devices must be regenerated so often as to be impractical. Second, when treating very high feed solution concentrations, for example greater than 10,000 ppm total dissolved solids (TDS), and particularly greater than 50,000 ppm TDS, bulk salt diffusion into traditional ion exchange membranes is likely to occur. Bulk salt absorption can dramatically reduce cell operating voltages to such low values that water-splitting reactions cannot occur (it theoretically requires about 2 V for each membrane). In this case, current is carried across the anion exchange-cation exchange layer boundary by direct migration of anions and cations, thus avoiding the formation of hydrogen ion and hydroxide ion via the water-splitting reaction at this boundary.

There is need for novel membranes, devices, and methods for the recovery of target ions from solutions, including from concentrated solutions. Novel membranes and devices that possess properties unattainable from traditional ion exchange resins are desirable. It is also desirable to provide membranes, devices, and methods, that do not rely on hazardous chemicals for operation (e.g., hydroxides or acids), and which recover target ions in product solutions without contamination by chemical eluants.

### SUMMARY

The present disclosure provides novel bipolar membranes that are efficiently regenerated in electrically regenerated ion exchange devices. The bipolar membranes, and their use in electrically regenerated ion exchange devices, may facilitate the recovery of target ions without the need for hazardous elution chemicals and without subsequent contamination from eluents. The membranes and/or devices of the present disclosure are configured to produce hydrogen ions and/or hydroxide ions in situ to allow for absorption of specific cations or anions without the addition of chemical acids and/or bases. This includes devices which induce water splitting within the bipolar membrane, as the cation exchange layer and the anion exchange layer are coupled and configured for hydraulic communication with sufficient permselectivity to prevent feed solution ion migration from carrying the current across the membranes rather than providing water splitting reaction. The membranes of the present disclosure may selectively retain and release target cations. The devices and methods of the present disclosure may facile recovery of a target cation from a feed solution. The devices and methods of the present disclosure may tolerate a wide range of feed solution concentrations. For example, the devices and methods of the present disclosure may be configured to facilitate water splitting primarily within the bipolar membrane and this may be suitable for feed solutions having less than about 10,000 ppm TDS. Likewise, the devices and methods of the present disclosure may be configured to facilitate water electrolysis primarily at a first electrode, and this may be suitable for feed solutions have greater than about 10,000 ppm TDS.

An aspect of the present disclosure relates to a membrane apparatus for selectively retaining and releasing a target cation, the membrane apparatus comprising: a cation exchange layer, wherein the cation exchange layer is permselective, and comprises a sorbing agent having a target cation binding coefficient and a hydrogen ion binding coefficient, and wherein the target cation binding coefficient is less than or equal to said hydrogen ion binding coefficient; and an anion exchange layer, wherein said anion exchange layer is permselective; and wherein said cation exchange layer and said anion exchange layer are coupled and configured for hydraulic communication to facilitate water splitting under an applied voltage.

In an embodiment of the present disclosure, the target cation comprises a lithium cation.

In an embodiment of the present disclosure, the cation exchange layer and the anion exchange layer are coupled and configured for hydraulic communication with sufficient permselectivity to facilitate water splitting under an applied voltage.

In an embodiment of the present disclosure, the sorbing agent comprises a metal oxide at least partially stripped of a metal.

In an embodiment of the present disclosure, the sorbing agent comprises a crown ether.

In an embodiment of the present disclosure, the sorbing agent comprises titanate, metatitanate, metatitanic acid, or a combination thereof.

In an embodiment of the present disclosure, the sorbing agent comprises between about 35% and about 50% of said cation exchange layer.

In an embodiment of the present disclosure, the membrane apparatus further comprises a second cation exchange layer, wherein said second cation exchange layer is at least partially interposed between said anion exchange layer and said cation exchange layer comprising, and wherein said cation exchange layer comprises and inorganic material.

Another aspect of the present disclosure relates to an electrically regenerated ion exchange apparatus for recovering a target cation from a feed solution, the ion exchange apparatus comprising: a single contiguous flow configuration from an inlet of the ion exchange apparatus to an outlet of the ion exchange apparatus, the configuration comprising a first electrode along a contiguous flow path of the ion exchange apparatus and a second electrode along the contiguous flow path of the ion exchange apparatus; and a membrane apparatus interposed between the first electrode and the second electrode, wherein the membrane apparatus comprises: a cation exchange layer comprising a sorbing agent comprising a target cation binding coefficient and a hydrogen ion binding coefficient, wherein the target cation binding coefficient is less than or equal to said hydrogen ion binding coefficient, and an anion exchange layer, wherein the ion exchange apparatus is configured to electrolyze water to generate hydroxide ions under an applied voltage.

In an embodiment of the present disclosure, ion exchange apparatus is configured to facilitate water splitting at a boundary of the cation exchange layer and the anion exchange layer.

In an embodiment of the present disclosure, ion exchange apparatus is configured to facilitate water electrolysis at the first electrode.

In an embodiment of the present disclosure, the first electrode of the ion exchange apparatus is a cathode.

In an embodiment of the present disclosure, the ion exchange apparatus is a plurality of ion exchange apparatuses.

In an embodiment of the present disclosure, wherein the sorbing agent of the apparatus comprises a metal oxide at least partially stripped of a metal.

In an embodiment of the present disclosure, the ion exchange apparatus further comprises a second cation exchange layer, wherein said second cation exchange layer is at least partially interposed between said anion exchange layer and said cation exchange layer comprising, and wherein said cation exchange layer comprises and inorganic material.

Another aspect of the present disclosure relates to a method of recovering a target cation from a feed solution using an electrically regenerated ion exchange apparatus, the method comprising: flowing the feed solution along a single contiguous flow path that encounters: a first electrode, a second electrode, and a membrane apparatus at least partially disposed between the first electrode and the second electrode, applying sufficient voltage at a first polarity across the first electrode and the second electrode to generate hydroxide ions at least partially disposed within the ion exchange apparatus; applying sufficient voltage at a second polarity across the first electrode and the second electrode to generate hydrogen ions at least partially disposed within the ion exchange apparatus; and eluting the target cation from the ion exchange apparatus.

In an embodiment of the method of present disclosure, splitting occurs primarily within the membrane apparatus.

In an embodiment of the method of present disclosure, water electrolysis occurs primarily at the first electrode.

In an embodiment of the method of present disclosure, the first electrode is a cathode.

In an embodiment of the method of the present disclosure, the membrane apparatus is a plurality of membrane apparatuses.

In an embodiment of the method of the present disclosure, the target cation comprises a lithium cation.

In an embodiment of the method of the present disclosure, the applied voltage is less than about 3 V.

In an embodiment of the present disclosure, the target cation is selectively retained and released to provide at least a 5-fold concentration increase relative to a competing cation.

In an embodiment of the present disclosure, the target cation is selectively retained and released to provide at least an 8-fold concentration increase relative to a competing cation.

In an embodiment of the present disclosure, the target cation is selectively retained and released to provide at least a 100-fold concentration increase relative to a competing cation.

In an embodiment of the present disclosure, the competing cation is a sodium cation, a potassium cation, a magnesium cation, a calcium cation, or a combination thereof.

In an embodiment of the present disclosure, the cation exchange layer and the anion exchange layer are coupled and configured for hydraulic communication with sufficient permselectivity to facilitate water splitting under an applied voltage of less than about 3 volts/bipolar membrane.

In an embodiment of the present disclosure, the cation exchange layer and the anion exchange layer are coupled and configured for hydraulic communication with sufficient permselectivity to facilitate water splitting under an applied voltage of less than about 5 volts/bipolar membrane.

In an embodiment of the present disclosure, the cation exchange layer has an ion exchange capacity of at least about 0.1 meq/cc.

In an embodiment of the present disclosure, the cation exchange layer has an ion exchange capacity of at least about 0.2 meq/cc.

In an embodiment of the present disclosure, the cation exchange layer has an ion exchange capacity of at least about 0.5 meq/cc.

In an embodiment of the present disclosure, the sorbing agent comprises an inorganic material, an organic material, or a combination thereof.

In an embodiment of the present disclosure, the sorbing agent comprises a metal oxide that has been at least partially stripped of lithium ions.

In an embodiment of the present disclosure, the sorbing agent comprises a crown ether.

In an embodiment of the present disclosure, the sorbing agent comprises a spinel compound.

In an embodiment of the present disclosure, the sorbing agent comprises a LiMFePO₄ compound, wherein M is Mn, Ti, Co, or a combination thereof.

In an embodiment of the present disclosure, the sorbing agent accounts for between about 20% and about 60% of the cation exchange layer.

In an embodiment of the present disclosure, the sorbing agent accounts for between about 35% and about 50% of the cation exchange layer.

In an embodiment of the present disclosure, the target cation binding coefficient of the inorganic material is at least about 10% less than the hydrogen binding coefficient of the sorbing agent.

In an embodiment of the present disclosure, the target cation binding coefficient of the inorganic material is at least about 50% less than the hydrogen binding coefficient of the sorbing agent.

In an embodiment of the present disclosure, the cation exchange layer further comprises a polymer binder.

In an embodiment of the present disclosure, the polymer binder is melt-processable.

In an embodiment of the present disclosure, the polymer binder comprises a polyolefin.

In an embodiment of the present disclosure, the polyolefin comprises a polypropylene, a polyethelyene, a polyvinyl difluoride, or a combination thereof.

In an embodiment of the present disclosure, the anion exchange layer has an ion exchange capacity of at least about 0.1 meq/cc.

In an embodiment of the present disclosure, the anion exchange layer has an ion exchange capacity of at least about 0.2 meq/cc.

In an embodiment of the present disclosure, the anion exchange layer has an ion exchange capacity of at least about 0.5 meq/cc.

In an embodiment of the present disclosure, the anion exchange layer comprises an organic material with a basic functional group.

In an embodiment of the present disclosure, the basic functional group is —NR₃A, —NR₂HA, —PR₃A, —SR₂A, —C₅H₅NHA, or a combination thereof, where R is a hydrocarbyl group and A is an anion.

In an embodiment of the present disclosure, the anion exchange layer further comprises a polymer binder.

In an embodiment of the present disclosure, the polymer binder is melt-processable.

In an embodiment of the present disclosure, the polymer binder comprises a polyolefin.

In an embodiment of the present disclosure, the polyolefin comprises a polypropylene, a polyethelyene, a polyvinyl difluoride, or a combination thereof.

In an embodiment of the present disclosure, the cation exchange layer is secured to the anion exchange layer.

In an embodiment of the present disclosure, the cation exchange layer and the anion exchange layer are configured to retain at least some permselectivity in the presence of a feed solution having less than about 10,000 ppm TDS.

In an embodiment of the present disclosure, the bipolar membrane further comprises a second cation exchange layer, and the second cation exchange layer is interposed between the anion exchange layer and the cation exchange layer comprising the inorganic material.

In an embodiment of the present disclosure, the second cation exchange layer comprises an organic material.

In an embodiment of the present disclosure, the organic material comprises a weakly acidic functional group.

In an embodiment of the present disclosure, the weakly acidic functional group has a pKa of between about 4 and about 7.

In an embodiment of the present disclosure, the bipolar membrane further comprises a porous layer adjacent to the cation exchange layer and the porous layer has an average pore diameter of at least 1 μm.

In an embodiment of the present disclosure, the average pore diameter is greater than 10 μm.

An aspect of the present disclosure relates to an electrically regenerated ion exchange device for recovering a target cation from a feed solution, the device comprising: a single contiguous flow path from an inlet of the device; a first electrode that is in the contiguous flow path of the device; a second electrode that is in the contiguous flow path of the device; and a bipolar membrane interposed between the first electrode and the second electrode, wherein the bipolar membrane comprises: a cation exchange layer that comprises a sorbing agent having a target cation binding coefficient and a hydrogen ion binding coefficient, wherein the target cation binding coefficient is less than or equal to the hydrogen ion binding coefficient, and an anion exchange layer, wherein the device is configured to generate hydroxide ions under an applied voltage.

In an embodiment of the present disclosure, the device is configured to facilitate water splitting primarily at the bipolar membrane.

In an embodiment of the present disclosure, the feed solution has less than about 10,000 ppm TDS.

In an embodiment of the present disclosure, the device is configured to facilitate water electrolysis primarily at the first electrode.

In an embodiment of the present disclosure, the feed solution has greater than about 10,000 ppm TDS.

In an embodiment of the present disclosure, the first electrode is a cathode.

In an embodiment of the present disclosure, the bipolar membrane is a plurality of bipolar membranes.

In an embodiment of the present disclosure, the plurality of bipolar membranes comprises between about 5 and about 50 bipolar membranes.

In an embodiment of the present disclosure, the plurality of bipolar membranes are oriented such that each anion exchange layer substantially faces the first electrode.

In an embodiment of the present disclosure, the device is a plate and frame device.

In an embodiment of the present disclosure, is a spiral bound device.

In an embodiment of the present disclosure, the target cation is a lithium cation.

In an embodiment of the present disclosure, the target cation is selectively retained and released to provide at least a 5-fold concentration increase relative to a competing cation.

In an embodiment of the present disclosure, the target cation is selectively retained and released to provide at least an 8-fold concentration increase relative to a competing cation.

In an embodiment of the present disclosure, the target cation is selectively retained and released to provide at least a 100-fold concentration increase relative to a competing cation.

In an embodiment of the present disclosure, the competing cation is a sodium cation, a potassium cation, a magnesium cation, a calcium cation, or a combination thereof.

In an embodiment of the present disclosure, the ion exchange apparatus is as characterized in one or more of paragraphs [0011] to [0019] and [0026] to [0088].

An aspect of the present disclosure relates to a method of recovering a target cation from a feed solution using a device, the method comprising: flowing the feed solution along a single contiguous flow path that encounters: a first electrode, a second electrode, and a bipolar membrane interposed between the first electrode and the second electrode, applying sufficient voltage at a first polarity across the first electrode and the second electrode to generate hydroxide ions in situ; applying sufficient voltage at a second polarity across the first electrode and the second electrode to generate hydrogen ions in situ; and eluting the target cation from the device.

In an embodiment of the present disclosure, water splitting occurs primarily within the bipolar membrane.

In an embodiment of the present disclosure, the feed solution has less than about 10,000 ppm TDS.

In an embodiment of the present disclosure, water electrolysis occurs primarily at the first electrode.

In an embodiment of the present disclosure, the feed solution has greater than about 10,000 ppm TDS.

In an embodiment of the present disclosure, the target cation is a lithium cation.

In an embodiment of the present disclosure, the target cation is selectively retained and released to provide at least a 5-fold concentration increase relative to a competing cation.

In an embodiment of the present disclosure, the target cation is selectively retained and released to provide at least an 8-fold concentration increase relative to a competing cation.

In an embodiment of the present disclosure, the target cation is selectively retained and released to provide at least a 100-fold concentration increase relative to a competing cation.

In an embodiment of the present disclosure, the competing cation is a sodium cation, a potassium cation, a magnesium cation, a calcium cation, or a combination thereof.

In an embodiment of the present disclosure, the apparatus specified in the method is as characterized in one or more of paragraphs [0012] to [0025] and [0033] to [0098].

In an embodiment of the present disclosure, the bipolar membrane specified in the method is as characterized in one or more of paragraphs [0013] to [0099].

These and other aspects, embodiments, features, objects, and/or advantages will be apparent from the description and drawings provided herein. The implementations, geometrical configurations, materials, ranges, and/or dimensions set out in the description and drawings provided herein are for exemplify various aspects and embodiments of the present disclosure, and are not intended to limit the scope of the present disclosure.

### BRIEF DESCRIPTION OF THE DRAWINGS

In the drawings and description provided herein, similar reference numerals indicate similar components. For sake of simplicity and clarity, not all drawings contain references to all the components and features, and references to some components and features may be found in only one drawing. Components and features of the present disclosure which are illustrated in other drawings can be readily inferred therefrom.

FIG. 1 depicts a schematic sectional diagram of a two-layer bipolar membrane in accordance with a first embodiment of the present disclosure;

FIG. 2 depicts a schematic sectional diagram of a three-layer bipolar membrane in accordance with a second embodiment of the present disclosure;

FIG. 3 depicts a schematic sectional diagram of a three-layer bipolar membrane in accordance with a third embodiment of the present disclosure;

FIG. 4 depicts a schematic sectional diagram of a four-layer bipolar membrane in accordance with a fourth embodiment of the present disclosure;

FIG. 5 depicts a schematic sectional diagram of an electrically regenerated ion exchange device in accordance with a fifth embodiment of the present disclosure;

FIG. 6 depicts a schematic sectional diagram of an electrically regenerated ion exchange device in accordance with a sixth embodiment of the present disclosure;

FIG. 7 depicts a plot of conductivity as a function of time;

FIG. 8 depicts a plot of conductivity as a function of time;

FIG. 9 depicts a plot of conductivity as a function of time; and

FIG. 10 depicts a plot of conductivity as a function of time. as described in Example 4.

### DETAILED DESCRIPTION

Bipolar membranes, electrically regenerated ion exchange devices, and methods of recovering target ions were reduced to practice in an embodiment featuring multilayer constructions. In the multilayer constructions, an anion exchange layer and a cation exchange layer are coupled and configured for hydraulic communication with sufficient permselectivity to prevent unidirectional ion migration from carrying the current across the entire membrane, thereby substantially reducing the voltage drop across each bipolar membrane. As such, they may be suitable for producing hydrogen ions and/or hydroxide ions in situ. The bipolar membranes of the present disclosure leverage this feature by pairing it with a sorbing agent that has: (i) selectivity for a target cation; and (ii) stronger thermodynamic affinity for sorbing (i.e. binding) a hydrogen ion over the target cation. Accordingly, the bipolar membranes of the present disclosure may selectively retain and release target cations in a deionization-regeneration cycle that doesn't rely on exogeneous acids and/or bases.

In the context of the present disclosure, “substantially selective” refers to orders of magnitude selectivity ratios. The orders of magnitude of the selectivity ratios may be about 10 fold to about 100 fold or about 100 fold to about 1000 fold.

In the context of the present disclosure, “sufficient voltage” refers to the amount of voltage required to generate hydroxide ions and/or hydrogen ions by water splitting and/or water electrolysis. The voltage may be at least about 1.5 V, about 1.5 V to about 5 V, about 2 V to about 4 V, about 2.5 V to about 3.5, or about 5 V.

The terms “bipolar membrane” and “membrane” are used interchangeably throughout the specification. The terms refer to a material that a current and/or voltage may be applied to and/or across.

The term “permselectivity” is defined in the specification and the claims as preventing unidirectional ion migration from carrying the current across the entirety of a membrane to reduce the voltage drop across each the membrane.

The term “water splitting” is defined in the specification and the claims as the separation of water into its constituent atoms. The separation can occur by any means and/or reaction, including, but not limited to electrolytic reaction, chemical reaction, mechanical mean, or a combination thereof.

The term “hydraulic communication” is defined in the specification and the claims as the migration water through a membrane.

The term “coupled” is defined in the specification and the claims as including, but not limited to, physically attached, secured, chemically attached, chemically bonded, adhered, electromagnetically connected, adhered, connected, or a combination thereof.

The term “polarity” is defined in the specification and the claims as the charge of a material, e.g., negative, positive, partially negative, and/or partially positive.

The binding coefficient of a target ion and/or hydrogen refers to its ability to bind to a sorbent. The binding coefficient associated with a target ion and sorbent or hydrogen and sorbent depends on a number of factors, including but not limited to, the chemical structure of the sorbent, functional molecules attached to the sorbent, the current applied to the sorbent and/or the target ion or hydrogen, the material of the sorbent, the concentration of the solution containing the target ion and/or hydrogen, the pore size of the sorbent for binding the target ion, the type and characteristics of the target ion, or a combination thereof. The binding coefficient may be a physical and/or chemical property of the sorbent specific to a target ion. A sorbent may have binding coefficient for each type (e.g., lithium, cobalt, nickel, aluminum, etc.) of target ion it binds to.

In the following description of the figures, the cation exchange layer and the anion exchange layer are referred to with “organic” or “inorganic” prefixes to indicate the category of their respective ion exchange functionalities. For example, the term “inorganic cation exchange layer” may be used to describe a cation exchange layer comprising an inorganic material that is selective for a target cation, and that has a target cation binding coefficient that is less than or equal to its hydrogen ion binding coefficient. Various types of organic and inorganic ion exchange functionalities are known to those skilled in the art and non-limiting examples are provided herein.

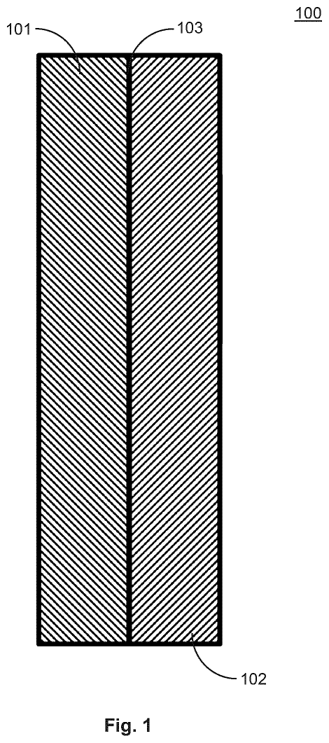

FIG. 1 shows two-layer bipolar membrane 100 comprising organic anion exchange layer 101 secured to inorganic cation exchange layer 102. In FIG. 1, the boundary at which water splitting occurs is identified with reference numeral 103. Water splitting may also occur at a distance from the boundary, with activity of water splitting decreasing with increasing distance from the boundary.

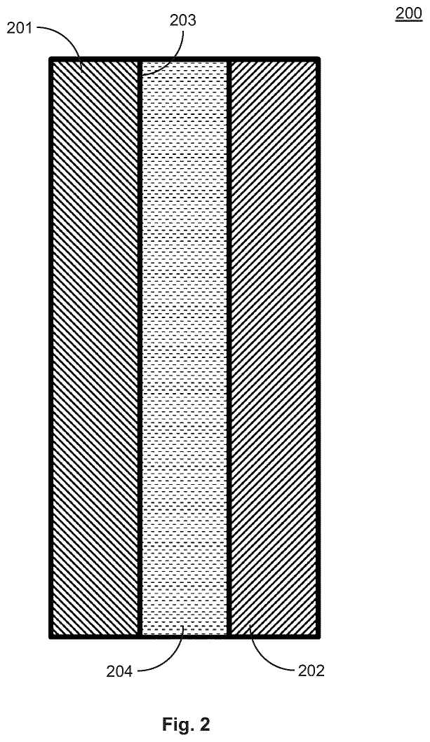

FIG. 2 shows three-layer membrane system 200 in which organic cation exchange layer 204 is interposed between organic anion exchange layer 201 and inorganic cation exchange layer 202. Organic cation exchange layer 204 is secured to both layers 201 and 202. The boundary at which water splitting primarily occurs is identified with reference numeral 203. Organic cation exchange layer 204 may comprise any one of a variety of cation exchange materials. The cation exchange material may include, but is not limited to, strong acid cation exchange resins, weak acid cation exchange resins, or a combination thereof. In an embodiment of the present disclosure, the molecular functional group is carboxylic acid (P—COOH, where P represents the polymer backbone) due to its pKa of ˜5.5. This property maintains the pH at the boundary with the inorganic material in the range ˜4-7 which may avoid degradation of inorganic material fillers which may be sensitive to very low pH values. Those skilled in the art who have benefited from the teachings of the present disclosure will recognize how this strategy may be extended to employ other ion exchange molecular groups with higher or lower pKa values to change the predominant pH range at the boundary with inorganic cation exchange layer 202. For example, a sulfonate functional group will provide pH values as low as 0-1 and is a less judicious choice if there is concern with inorganic material chemical stability.

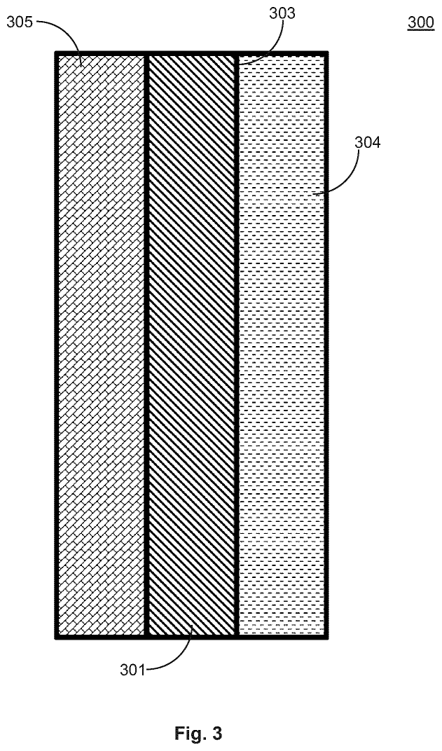

FIG. 3 depicts a schematic sectional diagram of three-layer bipolar membrane system 300 in which organic anion exchange layer 301 is interposed between organic cation exchange layer 304 and inorganic anion exchange layer 305. One can also moderate or control pH for inorganic materials bound to the organic anion exchange layer surface (FIG. 3) by suitable selection of the anion exchange functional group. The anion exchange functional group may include, but is not limited to, ammonium, dimethanolammonium, phosphonum, or a combination thereof. In bipolar membrane 300, the inorganic material is chosen for its selectivity for a target anion. For example, inorganic anion exchange layer 305, which may be sensitive to high pH (>10) can be secured to a weak base of the organic anion exchange layer 301 (e.g. having the tertiary amine, P—NR₂, SR₂ group). In this construction, organic cation exchange layer 304 is exposed to solution rather than interposed between organic anion exchange layer 301 and the inorganic anion exchange layer 305. A tertiary amine ion exchange group which may be located on the surface or periphery of the organic anion exchange layer 301 may control pH at an adjacent inorganic material boundary in the range ˜8-12 due to its pKa of ˜10. Alternatively, the selection of a quaternary ammonium anion exchange group may provide higher pH values at the boundary of the anion exchange layer surface in the pH range up to 13-14.

In FIGS. 2 and 3, organic anion exchange layers (201 and 301) and organic cation exchange layers 204 and 304 may have good permselectivity, e.g., where the voltage drop across a membrane is less than about 2 volts. Good permselectivity in turn provides effective water-splitting reactions in electrically regenerated ion exchange devices. In the 3-layer constructions, the permselectivity of the inorganic material may be much less important, enabling the use of a wider range of inorganic materials in the bipolar membranes of the present disclosure.

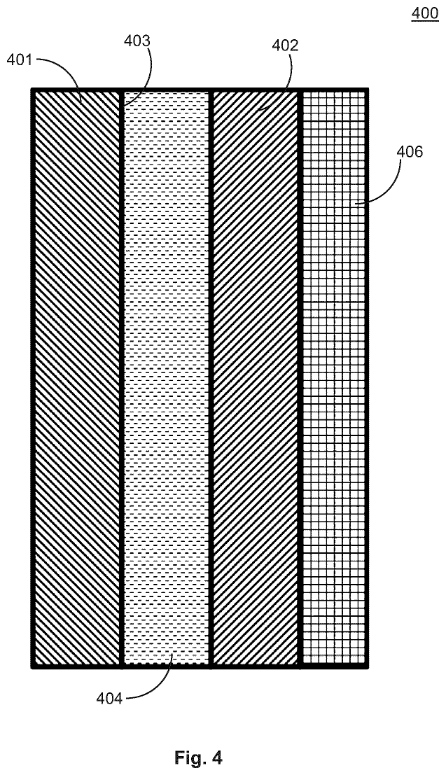

To provide greater surface area, one or both surfaces of the bipolar membrane of the present disclosure may be textured. Texturing of membranes serves two functions: it eliminates the need for a spacer often needed in the construction of a bipolar membrane cell to keep layers separated and provides improved surface area to allow improved ion-exchange capability (more accessible sites) relative to a flat membrane sheet. Alternatively, a porous layer of inorganic oxide may be secured to the outer surface of an inorganic cation exchange layer (such as layers 102 and 202 in FIGS. 1 and 2, respectively) or an inorganic anion exchange layer (such as layer 305 in FIG. 3). Such layers may be selective for target cations or anions, respectively) to effectively increase surface area further and promote mass transport of target ions. An example is bipolar membrane system 400 shown in FIG. 4. Bipolar membrane 400 is a four-layer construction that includes organic anion exchange layer 401, organic cation exchange layer 404, inorganic cation exchange layer 402, and porous layer 406 comprising an inorganic cation exchange material. Porous layer 406 is secured to inorganic cation exchange layer 402, which may be substantially non-porous. Porosity can be obtained from any number of methods, including but not limited to out-gassing of a chemical ingredient (e.g. blending of carbonate salts into the 406 during manufacturing followed by reaction with a dilute acid to release CO₂). For example, pores may be introduced into a polymeric film or membrane by blending Na₂CO₃ or NaCl into the membrane and submerging the membrane into dilute acidic solution or water, respectively, to dissolve the Na₂CO₃ or NaCl. Porosity can also be obtained by dissolution of a component of the layer (such as micronized NaCl), or mechanical distortion, of example, by placing the membrane into a press to form a pattern of ridges and thereby improve the membrane surface area relative to a flat sheet.

In an embodiment of the present disclosure, the inorganic cation or anion selective material and membranes are configured such that:
1. When the target ion is a cation, it can be replaced by hydrogen ion. When the target ion is an anion, it can be replaced by hydroxide ion.
2. The inorganic material has substantial capacity for the target ion (preferably >1 mmole/dry g).
3. The inorganic material is stable at the low and high pH values reached during electrically regenerated ion exchange device operation.
4. The inorganic material can be processed into thin sheets (preferably <0.5 mm thick to provide higher device membrane surface area per device volume).
5. Bipolar membranes comprising inorganic materials provide enough ionic conductivity when swollen or saturated with water to provide useful electrically regenerated ion exchange devices (such that cells operate at reasonable power levels). Bipolar membranes preferably exhibit specific resistances <1000 ohm-cm²).

Suitable organic anion and cation exchange materials comprise a variety of molecular functional groups. The inorganic material loading in the inorganic layer is typically in the range 20% to 60% by volume, more preferably in the range 35% to 50%. In this range the membrane layer produced therefrom generally has suitable ionic conduction and mechanical properties for practical use.

In an embodiment of the present disclosure, the cation exchange layer and/or the anion exchange layer may include a polymer binder. The polymer binder may be any material that has the necessary properties for membrane fabrication and use. In this case, the binder must be able to maintain cohesion or contact between the ion exchange layers, while in the presence of brine or water, without delamination, degradation, or dissolution. Furthermore, the binder must also be able to tolerate a wide range of pH (between 1 to 14) typical of normal operation. A preferred method of preparing the bipolar membrane articles of the present disclosure is to select a melt-processible (i.e. application of heat at temperatures between about 30° C. to about 80° C. to form a flowable fluid followed by cooling to form a solid and/or rigid material) polymer with a chemically stable (unaffected chemically or physically by acids or base or solvents) backbone. Most preferred are polyolefins such as polypropylenes, polyethylenes, polyvinyl difluoride, or polystyrenes, and copolymers comprising these monomers, among others. Those skilled in the art will recognize that other polymers and/or fabrication methods may be suitable for example casting from solvents, or direct synthesis of organic ion exchange membranes with subsequent chemical functionalization.

The electrically regenerated ion exchange devices of the present disclosure utilize the bipolar membranes described herein. Designs include plate and frame and spiral wound membrane constructions. Spiral wound membrane cartridge designs may be preferred for several reasons. They may enable the use of textured bipolar membrane which in turn may obviate the need for netting spacer and increases ion exchange surface area, and they do may not place the membrane under compression. The avoidance of netting spacer may enable packing more membrane in a device volume, and may eliminate the tendency of spacer to entrap solids, which may cause a decrease in device flow rate, and generally provide lower device operating pressures. Greater surface area may provide faster ion migration and diffusion into and out of the bipolar membranes of the present disclosure.

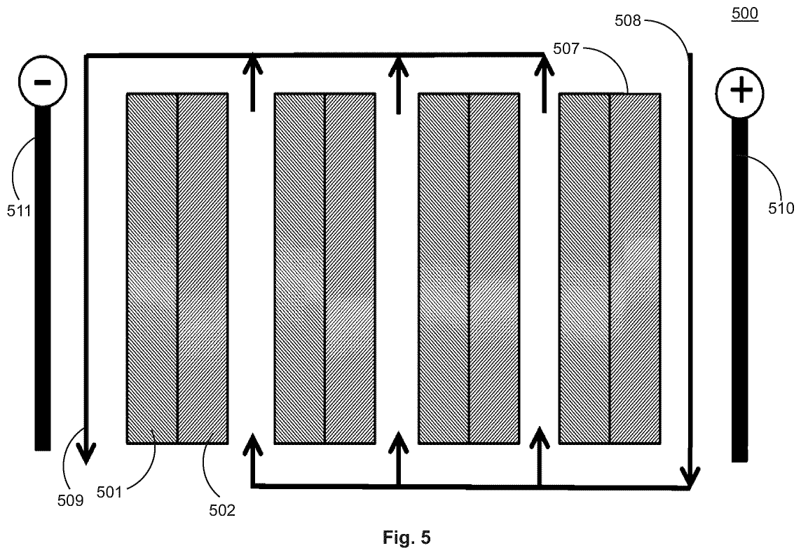

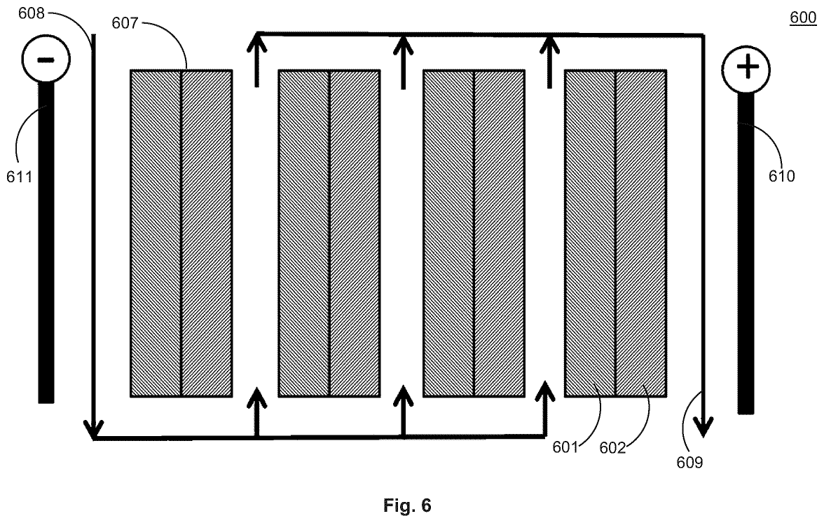

FIG. 5 and FIG. 6 depict schematic sectional diagrams of electrically regenerated ion exchange apparatuses 500 and 600, respectively, which are in accordance with embodiments of the present disclosure.

In FIG. 5, first electrode 510 is positioned in proximity to deionization inlet 508 and second electrode 511 is positioned in proximity to deionization outlet 509. First electrode 510 is positive polarity (i.e. the anode) and second electrode 511 is negative polarity (i.e. the cathode). In FIG. 6, first electrode 610 is positioned in proximity to deionization inlet 608, and second electrode 611 is positioned in proximity to a deionization outlet 609. First electrode 610 is negative polarity (i.e. the cathode), and second electrode 611 is positive polarity (i.e. the anode). In other respects, devices 500 and 600 are similar.

In FIG. 5, device 500 includes plurality of bipolar membranes 507, each of which comprises organic anion exchange layer 501 secured to inorganic cation exchange layer 502. In FIG. 6, device 600 includes plurality of bipolar membranes 607, each of which comprises organic anion exchange layer 601 secured to inorganic cation exchange layer 602. Other device embodiments of the present disclosure utilize other bipolar membrane configurations such as those described with reference to FIGS. 3, 4, and 5.

In each of devices 500 and 600, their respective organic anion exchange layers 501/601 face the same electrode. In FIG. 5 they face second electrode 511, while in FIG. 6 they face first electrode 610. An exchange layer faces an electrode if the exchange layer is positioned between a second layer and the electrode. The second layer may comprise any material, including, but not limited to, an exchange layer, a membrane layer, a structural layer, a porous layer, a boundary layer, or a combination thereof.

When treating relatively dilute feed solutions during deionization, the ion exchange membrane layers adjacent to boundaries such as those identified by reference numerals 103, 203, 303, and 403 in FIGS. 1-4 respectively exhibit good permselectivity. In the context of the present disclosure, good permselectivity means that both ion exchange membrane layers adjacent to the water-splitting boundary, substantially prevent ions in solution which have the same electric charge as the ion exchange groups affixed to the ion exchange material backbone from migrating through each layer. his condition may localize water-splitting in proximity to the boundary to carry current across the boundary. In an embodiment of the present disclosure, water-splitting at each boundary in a device may require about 2 V. More voltage may be required to drive current through the membrane layers and solution inside the device, and optionally to provide water electrolysis at the two electrodes. Therefore, for example, an electrically regenerated ion exchange device having 20 layers of bipolar membrane between the first and second electrodes may not provide water-splitting if the cell voltage is less than 40 V. In this case any current observed will be substantially carried across the boundaries by direct ionic migration in one or both directions (by anions and/or cations).

Without being bound to any particular theory, when sufficient voltage is applied to an electrically regenerated ion exchange device in accordance with the present disclosure, hydroxide ions (OH⁻_{w-s}) and hydrogen ions (H⁺_{w-s}) may be formed by water-splitting at the boundary between the anion exchange layer and the cation exchange layer. Rapid proton hopping may enable the appearance of a net hydroxide ion in the cation exchange layer (i.e. in proximity to the inorganic material). For example, when employing metatitanate, the hydroxide ions may react with hydrogen ion bound to the HₓLi_{y}TiO₃, and this may drive the absorption of cations, for example selectively absorbing lithium ion (Li⁺), from the feed solution as captured in Rxn. 1. Simultaneously, a reaction such as that captured in Rxn. 2 may occur in the anion exchange layer. Such reactions may represent the deionization stage of a deionization-regeneration cycle for the devices and methods of the present disclosure.

### Deionization:

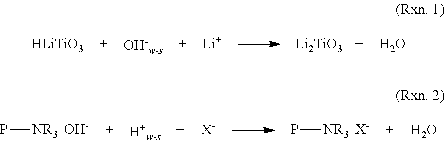

### Regeneration:

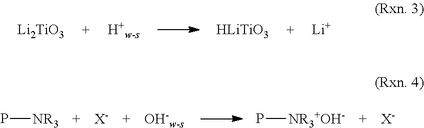

Following the deionization stage which may consume the working capacity of the electrically regenerated ion exchange device, the bipolar membranes may be regenerated by reversing the polarity of the electrodes and passing a solution through the device to collect the anions and cations absorbed during deionization. Example regeneration reactions are shown in Rxns. (3) and (4) using titanate as the inorganic material. The titanate has a stronger affinity for hydrogen ion than lithium or other monovalent cations, so the rejection of lithium ion by H⁺_{w-s} is likely efficient and may approach stoichiometric conversion. Rxns. 3 and 4 may occur in the cation and anion exchange layers, respectively.

In the case where deionization feed solution concentration is low enough that permselectivity prevails, as may be assumed when the voltage across each membrane is >>2 V (cell voltage/number of membrane layers between electrodes), then devices 500 and 600 (depicted in FIGS. 5 and 6, respectively) may be effective. More specifically, in device 500 first electrode 510 may be the anode and, in device 600, first electrode 610 may be the cathode. Water-splitting at the boundary between organic anion exchange layers 501 and 601, and the inorganic cation exchange layers 502 and 602, may drive the absorption of the target ion(s) from the feed solution.

In contrast, when treating higher feed concentrations during which ion exchange layer permselectivity is overwhelmed by bulk salt intrusion, electrical resistance during deionization may be so low that there is not sufficient voltage to cause water-splitting within the bipolar membranes. In this case, device 600 depicted in FIG. 6 may be effective, as first electrode 610 is the cathode and may produce hydroxide ions in proximity to deionization inlet 608 by water electrolysis as captured in Rxn. 5.

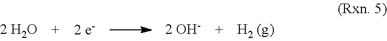

Rxn. 6 captures a target metal ion (M⁺) absorption step is using metatitanic acid as the example inorganic material. This may enable reaction 6 to occur for lithium in solution.

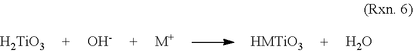

Furthermore, in this situation where water-splitting may not occur, it may be advantageous to utilize electrically regenerated ion exchange devices which provide higher ratios of cathode electrolysis product (e.g. moles of hydroxide produced via Rxn. 5) by increasing current for a given device bipolar membrane surface area. This may increase the absorption of a target ion, for example M⁺ in Rxn. 6. Without the reaction of inorganic material with hydroxide, the target ion may not be absorbed. An obvious means to accomplish the increase in electrolysis production of hydroxide is to increase electrical power, but since power increases as I²R (where I is current and R is cell resistance), power requirements increase rapidly for a given cell design when increasing current. To reduce the power necessary to provide a desired ratio of hydroxide product in Rxn. 5 to membrane surface area, the electrically regenerated ion exchange device may be configured with less bipolar membrane area per device (or relative to electrode surface area). Those skilled in the art who have benefited from the teachings of the present disclosure will recognize that the appropriate configuration depends on the consideration of electrode (capital) cost to power (operation) cost.

In an embodiment of the present disclosure, the deionization stage is followed by a flushing stage to replace feed solution in the device prior to the regeneration stage. It may be preferable to select ion exchange layer materials which absorb less feed solution in order to reduce the time and volume for sufficient flushing. The flushing step may also employ external deionization equipment, for example electrically regenerated ion exchange or reverse osmosis equipment, which continuously remove salt from the flush solution to enable recycling of the flush solution through the apparatus of the present disclosure and minimize water usage. Flushing may be performed with or without cell power.

During the regeneration stage the electrode polarity is reversed relative to the deionization stage. The feed solution for regeneration may be purified water, tap water, local water, effluent from a prior regeneration stage, or a combination thereof. Preferably the regeneration feed solution is not so concentrated as to prevent water-splitting from occurring in the bipolar membrane.

If the feed solution during regeneration is so concentrated as to reduce cell operating voltage to the point where water-splitting reaction cannot occur, then the first electrode may be configured as the anode during regeneration to produce hydrogen ion during electrolysis at the first electrode which in turn replaces the target ion absorbed by the bipolar membrane during the previous deionization step. Titanate is used as an example to capture this approach in Rxn. 7.

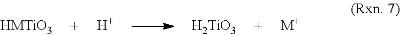

The use of electrolytically produced hydrogen ion, H⁺, at the electrode positioned at the feed solution inlet, or hydrogen ion from the water-splitting reaction, H⁺_{w-s}, avoids the need for acid or base chemicals for the elution of the target ion from the inorganic media. This may in turn eliminate the environmental risks associated with the use of chemicals for elution, and provide product solutions uncontaminated with elution chemicals which may otherwise be required to elute the target ion from the inorganic material.

In the context of the present disclosure, a “sorbing agent” is one which reversibly binds a target ion. The sorbing agent may release the target cation upon reaction with hydrogen ion produced in the water-splitting reaction in the ion exchange system. The sorbing agent may comprise an inorganic material, an organic material, or a combination thereof. The inorganic material may be any substantially insoluble framework, that has the suitable dimensions and electronic characteristics for selectively adsorbing specific ions and having stronger thermodynamic affinity for adsorbing (i.e. binding) a hydrogen ion over the target cation. By way of example, the sorbing agent may comprise a metal oxide that has been at least partially stripped of a metal, a layered double hydroxide material that has been at least partially stripped of a metal, a spinel compound, and/or a LiMFePO₄ compound, wherein M is Mn, Ti, Co, or a combination thereof. The metal may be the same metal as the target ion. For example, a sorbing agent may be stripped of Li metal to provide space for the sorbing of Li ion. By way of example, the organic material may be a crown ether, a porphyrin, an organophosphonate, a sulphonate, a carboxylate, or a combination thereof. Depending on the specific inorganic or organic material, the binding may result from primarily electrostatic forces, primarily covalent forces, or a combination of electrostatic and covalent forces. The valences of the metals in the inorganic material may vary. By way of example, titanium atoms in a titanate-based material may be in them 4+ oxidation state, while manganese elements in a lithium manganese oxide-based material may have oxidations states ranging from 2+ to 6+. The inorganic material may be attached to the surface or embedded in the cation exchange layer. For example, the inorganic material may be mixed with a polymer that generates the backbone of the cation exchange layer—or another organic component. The polymer inorganic material may be distributed substantially randomly in the cation exchange layer, and the cation exchange layer may be combined with other layer(s), such as an anion exchange layer, to generate a bipolar membrane. In an embodiment of the present disclosure, the bipolar membrane comprises a cation exchange layer and an anion exchange layer—each carries a partial charge that is opposite to its selectivity (e.g. the cation-exchange membrane is partially negatively charged).

The sorbing agent may comprise a high selectivity for the target ion over other metals by at least 1 to 4 orders of magnitude compared to other ions in solution. The sorbing agent may also have fast kinetics, with at least 80% adsorbed within the first 30 minutes. The exchange or release may be mediated by the addition of dilute acid (with concentration <0.2M), specifically through exchange of cations on binding sites with protons.

In the context of the present disclosure, having a target cation binding coefficient and a hydrogen ion binding coefficient, wherein the target cation binding coefficient is less than or equal to the hydrogen ion binding coefficient may facilitate elution of the target cation via a regeneration reaction such as shown in Rxn. 3 or Rxn. 7.

In an embodiment of the present disclosure, the cation exchange layer and the anion exchange layer are coupled and configured for hydraulic communication with sufficient permselectivity to facilitate water splitting. Combining this with an inorganic material having a target cation binding coefficient that is less than or equal to its hydrogen ion binding coefficient may facilitate a deionization-regeneration cycle that obviates the need for hazardous elution chemicals, as hydrogen ions and/or hydroxide ions are produced in situ. The hydrogen ions and/or hydroxide ions may impart localized and/or temporary pH changes within the bipolar membrane. For example, deionization (e.g. leading to retention of the target cation) may occur at a pH between about 8 and about 12 while regeneration (e.g. leading to release of the garget cation) may occur at a pH between about 1 and about 4.

In an embodiment of the present disclosure, the deionization-regeneration cycle may be utilized to recovery target ions from a feed solution. The feed solution may be an aqueous solutions such as a brine. The constitutions of feed solutions suitable for use with the membranes, devices, and/methods of the present disclosure may vary widely. For example, brines having total dissolved solids (TDS) vary from about 50 ppm to about 5,000 ppm, about 5,000 ppm to about 10,000 ppm, about 10,000 ppm to about 100,000 ppm or about 100,000 to about 250,000 ppm may be suitable. With respect to cation loading, suitable brines may comprise varying concentrations of lithium, sodium, potassium, calcium, magnesium, or combinations thereof. For example, a brine may comprise about 1000-25000 ppm K⁺, about 1000-100000 ppm Na⁺, about 500-1000 ppm Lit, and about 25-100 ppm Ca²⁺. This corresponds to a total of about 5000-250000 mg/L TDS with CI as the balancing anion. In an embodiment of the present disclosure, an electrically regenerated ion exchange device may be used in a process flow that involves pretreatment. Pretreatment may, for example, involve generating a relatively clean stream by using an extraction column, concentrating the eluate produced therefrom, and polishing with chemical additives. In an embodiment of the present disclosure, the target cation is a lithium cation. In an embodiment of the present disclosure, the target cation may be selectively retained and released to provide at least a 5-fold concentration increase, at least an 8-fold concentration increase, or at least a 100-fold concentration increase relative to a competing cation. In an embodiment of the present disclosure, the competing cation may be a sodium cation, a potassium cation, a magnesium cation, a calcium cation, or a combination thereof.

In an embodiment of the present disclosure, the cation exchange layer and the anion exchange layer are coupled and configured for hydraulic communication with sufficient permselectivity to facilitate water splitting under an applied voltage of less than about 3 volts/bipolar membrane, or less than about 5 volts/bipolar membrane.

In an embodiment of the present disclosure, the cation exchange layer has an ion exchange capacity of at least about 0.1 meq/cc, at least about 0.2 meq/cc, or at least about 0.5 meq/cc. The sorbing agent may account for between about 20% and about 60% of the cation exchange layer, or between about 35% and about 50% of the cation exchange layer. The target cation binding coefficient of the inorganic material may be at least about 10% less than the hydrogen binding coefficient of the sorbing agent, or at least about 50% less than the hydrogen binding coefficient of the sorbing agent.

In an embodiment of the present disclosure, the cation exchange layer further comprises a polymer binder. The polymer binder may be melt-processable. The polymer binder may comprise a polyolefin. The polyolefin may comprise a polypropylene, a polyethelyene, a polyvinyl difluoride, or a combination thereof.

In an embodiment of the present disclosure, the anion exchange layer has an ion exchange capacity of at least about 0.1 meq/cc, at least about 0.2 meq/cc., or at least about 0.5 meq/cc. The anion exchange layer may comprise an organic material with a basic functional group. The basic functional group may be —NR₃A, —NR₂HA, —PR₃A, —SR₂A, —C₅H₅NHA, or a combination thereof, where R is a hydrocarbyl group and A is an anion. The anion exchange layer may further comprise a polymer binder. The polymer binder may be melt-processable. The polymer binder may comprise a polyolefin. The polyolefin may comprise a polypropylene, a polyethelyene, a polyvinyl difluoride, or a combination thereof.

In an embodiment of the present disclosure, the cation exchange layer is secured to the anion exchange layer.

In an embodiment of the present disclosure, the cation exchange layer and the anion exchange layer are configured to retain at least some permselectivity in the presence of a feed solution having less than about 10,000 ppm TDS.

In an embodiment of the present disclosure, the bipolar membrane further comprises a second cation exchange layer, and the second cation exchange layer is interposed between the anion exchange layer and the cation exchange layer comprising the inorganic material. The second cation exchange layer may comprise an organic material. The organic material may comprise a weakly acidic functional group. The weakly acidic functional group may have a pKa of between about 4 and about 7.

In an embodiment of the present disclosure, the bipolar membrane further comprises a porous layer adjacent to the cation exchange layer and the porous layer has an average pore diameter of at least 1 μm. The average pore diameter may be greater than 10 μm.

In an embodiment of the present disclosure, the electrically regenerated ion exchange device is configured to facilitate water splitting primarily at the bipolar membrane. The bipolar membrane may be a plurality of bipolar membranes. The plurality of bipolar membranes may comprise between about 5 and about 50 bipolar membranes. The plurality of bipolar membranes may be oriented such that each anion exchange layer substantially faces the first electrode.

In an embodiment of the present disclosure, the electrically regenerated ion exchange device is configured to facilitate water electrolysis primarily at the first electrode. The first electrode may be a cathode.

In an embodiment of the present disclosure, the device is a plate and frame device. In an embodiment of the present disclosure, is a spiral bound device.

### Example 1

Lithium titanate (Li₂TiO₃) was known to meet the first two of the five items listed in paragraph above, efficient replacement of lithium by hydrogen ion and high lithium exchange capacity, and was speculated to meet item 3, good stability at low and high pH. The preparation and testing of useful lithium selective bipolar membranes meeting items 4 and 5, processing into thin sheets and good ionic conductivity, are detailed below.

In Table 1 are summarized two lithium titanate membrane formulations prepared for use in bipolar membranes. Materials were mixed in 50 cc Brabender plastic processing equipment with a polyolefin binder, then pressed into thin slabs using a hot press.

TABLE 1
Lithium Titanate Formulations

| | Density | EN145-140 | EN145-141 | EN145-140 | EN145-141 |
|---|---|---|---|---|---|
| Ingredient | (g/cc) | Vol % | Vol % | Wt % | Wt % |
| Lithium Titanate | 3.43 | 41.5 | 51.2 | 73.0 | 80.0 |
| Polyolefin Binder | 0.90 | 58.5 | 48.8 | 27.0 | 20.0 |

As expected, the 51.2 vol % compound had just enough structural integrity to form into sheets 0.10 mm thick, 15 cm×15 cm area. They were slightly brittle (cracking when a corner was bent on itself). The 41.5 vol % material flowed more readily and was not brittle, providing thinner, 0.030 mm, sheets. The swelling and specific resistance of these two inorganic materials and single sheets are shown in Table 2. The specific resistances were quite low, and suitable for the bipolar membranes of the present disclosure.

TABLE 2
Lithium Titanate Membrane Properties

| | EN145-140 | EN145-141 |
|---|---|---|
| Property | RS148-33 | RS148-32 |
| Volume % lithium titanate | 41.5 | 51.2 |
| Swelling (%) | 2 | 2 |
| Specific Resistance (ohm-cm²) | 46 | 7.5 |

The two inorganic materials in Table 2, and a third formulation with a titanate loading of 45.4 vol %, were used to prepare four sets of bipolar membranes (Table 3). Organic anion exchange material was prepared with 45 wt % quaternary ammonium ion exchange resin powder mixed with the same polyolefin material. Organic cation exchange material was prepared with 50 wt % weak acid cation exchange resin powder. The three constructions were laminated in the hot press followed by swelling with water. The specific resistances correlated with the titanate loading in the inorganic cation exchange layer (more titanate, lower resistance).

TABLE 3
Properties of Bipolar Membranes Comprising Inorganic Layers

| | | Plate | | |
|---|---|---|---|---|
| | No. of | and | | Specific |
| | Membrane | Frame | | Resistance |
| Property | Layers | Cell | Swelling | (ohm-cm²) |
| Organic Anion / 41.5 vol % | 2 | S288 | 8% | 91 |
| titanate | | | | |
| Organic Anion/ Organic | 3 | S289 | 8% | 230 |
| Cation / 41.5 vol % titanate | | | | |
| Organic Anion/ Organic | 3 | S292 | 9% | 174 |
| Cation / 45.4 vol % titanate | | | | |
| Organic Anion/ Organic | 3 | S290 | 8% | 142 |
| Cation / 51.2 vol % titanate | | | | |

### Example 2

Plate and frame devices were assembled from both 2 layer (cell S288) and 3 layer (cell S289) bipolar membranes using the 41.5 vol % titanate loading and characterized for their absorption (i.e. deionization) and subsequent release (i.e. regeneration) of LiCl or NaCl from feed solutions comprising 7 mM of one salt or the other. The plate and frame cells comprised seven (7) bipolar membranes trimmed to 14 cm×7 cm with thicknesses of ˜1.0 mm. The cells were powered with limits of 260 V and 240 mA. Flow rates during deionization were 50 mL/min, and seven (7) consecutive 50 mL samples were collected (350 mL total). The conductivity of the effluent was measured for each 50 mL sample. The results for the two devices are presented in Table 4.

TABLE 4
Comparison of Two Layer and Three Layer Bipolar
Membranes. Feed Solution is 710 μS/cm.

| | Conductivity | Conductivity | Conductivity |
|---|---|---|---|
| | LiCl; Cell S288 | LiCl; Cell S288 | NaCl; Cell S288 |
| | 2 layer, 41.5% | 3 layer, 41.5% | 2 layer, 41.5% |
| Minutes | media | media | media |
| 1 | 133 | 42 | |
| 2 | 458 | 45 | 140 |
| 3 | 574 | 49 | 185 |
| 4 | 498 | 45 | 215 |
| 5 | 511 | 78 | 208 |
| 6 | 524 | 128 | 255 |
| 7 | 575 | 169 | 272 |
| 8 | 615 | | |
| 9 | 684 | | |
| 10 | 705 | | |

From Table 4, it is apparent that the three-layer cell S289 provided much better LiCl absorption during the deionization step. For the two-layer construction (cell S288), the LiCl feed solution conductivity dropped from 710 μS/cm to 498 μS/cm at 4 minutes, compared to the result with the three-layer construction (cell S289) which provided effluent of only 45 μS/cm at 4 minutes. The selectivity for lithium ions over sodium ions was suggested by the poorer deionization result using cell S289 for deionization of the same concentration of NaCl; at 4 minutes the NaCl deionization effluent was 215 μS/cm.

### Example 3

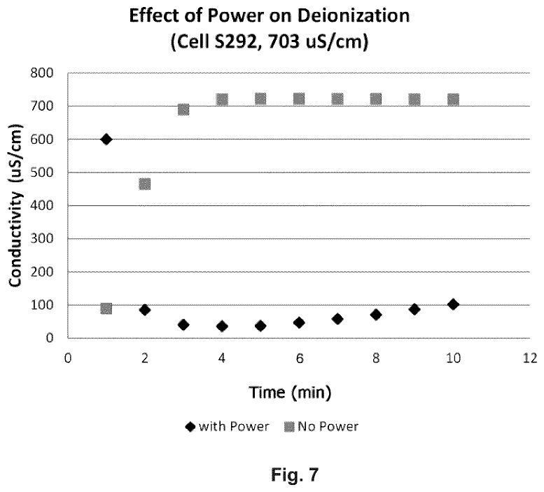

Deionization Rxns. 1 and 2 involve the formation of the water-splitting products H⁺_{w-s} and OH⁻_{w-s} which are created in proximity to the anion-cation exchange membrane boundary when sufficient voltage is applied and when both layers have suitably high permselectivity. FIG. 7 highlights the importance of electrical power for deionization using cell S292. In the absence of power, the effluent conductivity rapidly rose to the influent value (703 μS/cm, 7 mM LiCl) where it remained until flow was stopped at 10 minutes. The lower conductivities measured in the first 2 minutes without power were the result of the cell initially being full of distilled water. At this experiment's flow rate of 50 mL/min, this void volume (80 mL) was replaced by 7 mM LiCl feed solution in the first ˜2 minutes.

When power was subsequently applied to the cell during deionization, a much different result was obtained. The TDS of the effluent rapidly dropped to 35 μS/cm at ˜4 minutes, then slowly rose to 100 μS/cm over the 10 minute test. Power was employed to produce OH⁻_{w-s}, which reacted with hydrogen ion strongly bonded to the titanate media, thereby enabling the binding of Li+ from solution according to Rxn 1. In the absence of power, the Lit ion was unable to replace H⁺ on the titanate—proof of the affinity of the titanate media for hydrogen ion.

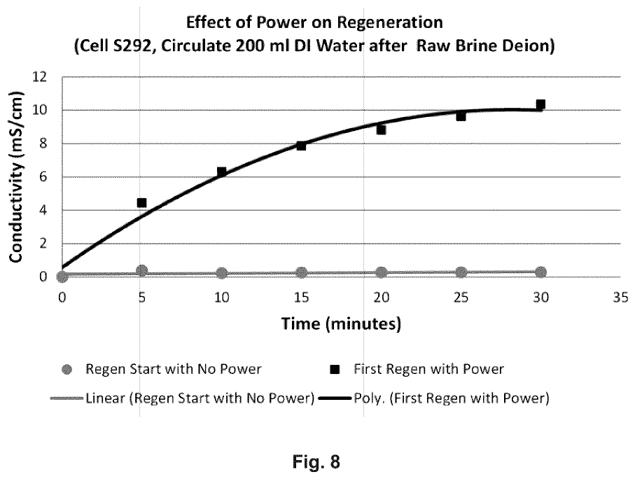

A similarly dramatic effect of power was seen for the regeneration step in the plot of FIG. 8 using plate and frame cell S292 after a deionization step using very concentrated salt solution (conductivity was 236 mS/cm, or 236,000 μS/cm). Regeneration first involved reversing the electrode polarity, and in this particular experiment 200 cc of distilled water was circulated through the cell with a pump while measuring the conductivity of the circulating solution. As seen in FIG. 8, without regeneration power there was little to no membrane regeneration and little to no increase in circulating solution conductivity, because the water-split ions were absent, preventing Rxns. 3 and 4. When power was subsequently applied to this cell, salt rejection into the distilled water circulating through the cell began immediately, reaching 10 mS/cm (10,000 μS/cm) conductivity in 30 minutes.

### Example 4

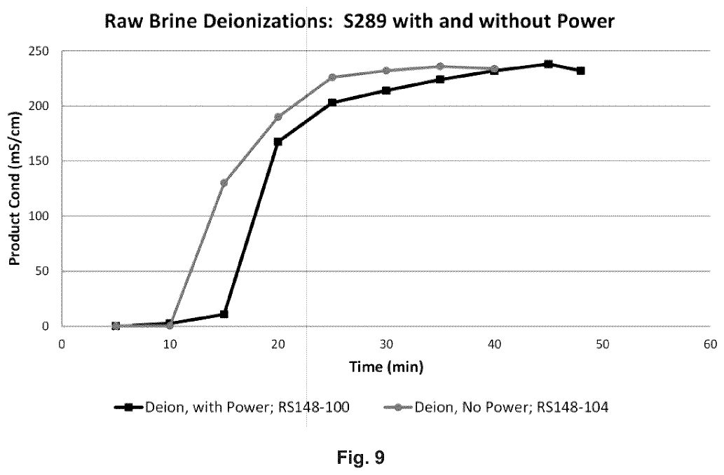

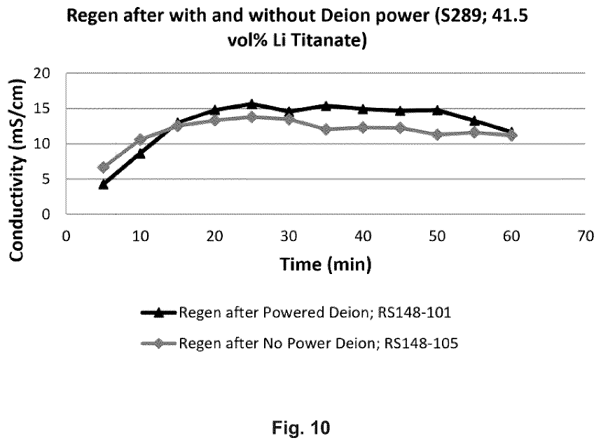

After more than twenty dilute LiCl solution experiments using 7 mM LiCl feed solution (as in Example 2), cell S289 was used to treat mineral brine. Conductivity measurements were used to monitor performance in real time, followed by ICP (intrinsically coupled plasma) analyses of selected samples to measure individual ion concentrations. Brine was treated with and without deionization power, each experiment followed by a powered regeneration. The experiment without power provided a baseline to account for brine effluent dilution by distilled water in the cell at the start as shown in FIG. 9. It similarly provided a baseline during regeneration, accounting for the rejection of lithium originally in the lithium titanate inorganic material used to fabricate cell S289 as shown in FIG. 10. The differences between the red and blue plots without and with power showed a clear net absorption of salt from raw brine during deionization, and after a flush, its rejection during regeneration.

Two regeneration effluents were collected from 0-30 min (Regen Effluent 1) and 30-60 minutes (Regen Effluent 2) flow by passing distilled water through the cell at 5 mL/min. The ICP elemental analyses of Regen Effluent 1 and 2 solutions are reported in Table 5, along with raw brine and the deionization effluent. The reduction in deionization effluent concentrations (e.g. for lithium ion, from 101 to 75 mmoles/L in Table 5), was largely due to dilution of the 240 mL of treated raw brine by the ˜75 ml of distilled water in the pump and cell before the start of deionization.

TABLE 5

| | ICP Results | | | | | | | | |
|---|---|---|---|---|---|---|---|---|---|
| | | | | | | | | Regen | Regen |
| | Deion | Regen | Regen | | Deion | Regen | Regen | Effluent 1 | Effluent 2 |
| | Effluent | Effluent 1 | Effluent 2 | Raw | Effluent | Effluent 1 | Effluent 2 | RS148- | RS148- |
| | RS148- | RS148- | RS148- | Brine | RS148- | RS148- | RS148- | 101-1 | 101-2 |
| | 100 | 101-1 | 101-2 | mmoles/L | 100 | 101-1 | 101-2 | mmoles | mmoles |
| | ppm element | | | mmoles/L | | | | 0.15 L | 0.14 L |
| Li | 524 | 71 | 277 | 101 | 75.5 | 10.2 | 39.9 | 1.53 | 5.59 |
| Na | 55780 | 1052 | 674 | 3953 | 2425.2 | 45.7 | 29.3 | 6.86 | 4.10 |
| K | 17290 | 450 | 217 | 604 | 442.2 | 11.5 | 5.5 | 1.73 | 0.78 |
| Mg | 2626 | 2.5 | 10.5 | 396 | 108.0 | 0.10 | 0.43 | 0.015 | 0.060 |
| Ca | 368 | 2.5 | 2.5 | 15 | 9.2 | 0.06 | 0.06 | 0.009 | 0.009 |
| B | 230 | 2.7 | 2.5 | 37 | 21.3 | 0.2 | 0.2 | 0.037 | 0.032 |

The lithium concentration in Regen Effluent 1 is reduced by the initial 60 cc of distilled water in the cell at the start of regeneration (the cell void volume) because some of this volume is pumped out before substantial electrical regeneration has occurred. The much higher lithium concentration for Regen Effluent 2 in Table 5 had a contribution from the continued rejection of lithium ion from the lithium titanate material used to original fabricate the electrically regenerated ion exchange cell.

The ratios of lithium to sodium, potassium and divalent ions are summarized in Table 6—all three ratios show selective lithium rejection into the regeneration effluents. The exclusion of divalent ions magnesium and calcium was very high—with the Li/M²⁺ ratio increased by 255-fold.

TABLE 6

| | Ratio in Raw | Ratio in | Increase in Li/M in |
|---|---|---|---|
| Ratio | Brine | Effluent | Effluent 1 |
| Li/Na | 0.026 | 0.22 | 8.5-fold |
| Li/K | 0.17 | 0.88 | 5.1-fold |
| Li/M²⁺ | 0.25 | 64 | 255-fold |

While particular aspects of the subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Note that the same features of the present invention may be represented by more than one numerals in the specification and drawings. For example, a feature denoted by numeral 100 in FIG. 1 may be denoted by 200 in FIG. 2, 300 in FIG. 3, etc. Features denoted with the name numeral in different figures are the equivalent and/or same feature but in different embodiments and should be considered equivalent and/or the same for the purposes of interpreting the specification and/or drawings.

It will be understood by those within the art that, in general, terms used herein, and especially in the appended claims are generally intended as “open” terms (e.g., the term “comprising” should be interpreted as “including but not limited to”,” the term “having” should be interpreted as “having at least,” the term “has” should be interpreted as “has at least,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise.

Throughout this application, the terms “in an embodiment”, “in one embodiment”, “in an embodiment”, “in several embodiments”, “in at least one embodiment”, “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the subject matter.

The term of degree “substantially”, as used herein means a reasonable amount of deviation of the modified term such that the end result is not significantly changed. The term “substantially” should be construed as including a deviation of +5% of the modified term if this deviation would not negate the meaning of the term it modifies. The terms of degree “about” and “approximately should be construed as including a deviation of ±20%. Other terms of degrees should be construed as including a deviation of ±5% of the modified term.

The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary membranes and/or devices and/or methods are representative of more general processes and/or devices and/or technologies taught elsewhere herein, such as in the claims filed herewith and/or elsewhere in the present application.

1. A membrane apparatus for selectively retaining and releasing a target cation, said membrane apparatus comprising:
a cation exchange layer, wherein said cation exchange layer is permselective, and comprises a sorbing agent, wherein said sorbing agent comprises a target cation binding coefficient and a hydrogen ion binding coefficient, and wherein said target cation binding coefficient is less than or equal to said hydrogen ion binding coefficient;
an anion exchange layer, wherein said anion exchange layer is permselective; and
wherein said cation exchange layer and said anion exchange layer are coupled and configured for hydraulic communication to facilitate water splitting under an applied voltage.

2. The membrane apparatus of claim 1, wherein the target cation comprises a lithium cation.

3. The membrane apparatus of claim 1, wherein said cation exchange layer and said anion exchange layer are coupled and configured for hydraulic communication with sufficient permselectivity to facilitate water splitting under an applied voltage.

4. The membrane apparatus of claim 1, wherein said sorbing agent comprises a metal oxide at least partially stripped of a metal.

5. The membrane apparatus of claim 1, wherein said sorbing agent comprises a crown ether.

6. The membrane apparatus of claim 1, wherein said sorbing agent comprises titanate, metatitanate, metatitanic acid, or a combination thereof.

7. The membrane apparatus of claim 1, wherein said sorbing agent comprises between about 35% and about 50% of said cation exchange layer.

8. The membrane apparatus of claim 1, further comprising a second cation exchange layer, wherein said second cation exchange layer is at least partially interposed between said anion exchange layer and said cation exchange layer comprising said sorbing agent.

9. An electrically regenerated ion exchange apparatus for recovering a target cation from a feed solution, said ion exchange apparatus comprising:
a single contiguous flow configuration from an inlet of said ion exchange apparatus to an outlet of said ion exchange apparatus, said configuration comprising a first electrode along a contiguous flow path of said ion exchange apparatus and a second electrode along said contiguous flow path of said ion exchange apparatus; and
a membrane apparatus interposed between said first electrode and said second electrode, wherein said membrane apparatus comprises:
a cation exchange layer comprising a sorbing agent comprising a target cation binding coefficient and a hydrogen ion binding coefficient, wherein said target cation binding coefficient is less than or equal to said hydrogen ion binding coefficient; and
an anion exchange layer;
wherein said ion exchange apparatus is configured to electrolyze water to generate hydroxide ions under an applied voltage.

10. The ion exchange apparatus of claim 9, configured to facilitate water splitting at a boundary of said cation exchange layer and said anion exchange layer.

11. The ion exchange apparatus of claim 9, configured to facilitate water electrolysis at said first electrode.

12. The ion exchange apparatus of claim 9, wherein said first electrode is a cathode.

13. The ion exchange apparatus of claim 9, wherein said ion exchange apparatus is a plurality of ion exchange apparatuses.

14. The ion exchange apparatus of claim 9, wherein the target cation comprises a lithium cation.

15. The ion exchange apparatus of claim 9, wherein said cation exchange layer and said anion exchange layer are coupled and configured for hydraulic communication with sufficient permselectivity to facilitate water splitting under an applied voltage.

16. The ion exchange apparatus of claim 9, wherein said sorbing agent comprises a metal oxide at least partially stripped of a metal.

17. The ion exchange apparatus of claim 9, wherein said sorbing agent comprises a crown ether.

18. The ion exchange apparatus of claim 9, wherein said sorbing agent comprises titanate, metatitanate, metatitanic acid, or a combination thereof.

19. The ion exchange apparatus of claim 9, wherein said sorbing agent comprises between about 35% and about 50% of said cation exchange layer.

20. The ion exchange apparatus of claim 8, further comprising a second cation exchange layer, wherein said second cation exchange layer is at least partially interposed between said anion exchange layer and said cation exchange layer, and wherein said cation exchange layer comprises an inorganic material.

21. A method of recovering a target cation from a feed solution using an electrically regenerated ion exchange apparatus, the method comprising:
flowing the feed solution along a single contiguous flow path that encounters:
a first electrode,
a second electrode, and
a membrane apparatus comprising a cation exchange layer and an anion exchange layer, wherein said cation exchange layer comprises a sorbing agent, and wherein the membrane apparatus is at least partially disposed between the first electrode and the second electrode;
applying sufficient voltage at a first polarity across the first electrode and the second electrode to generate hydroxide ions at least partially disposed within the ion exchange apparatus;
applying sufficient voltage at a second polarity across the first electrode and the second electrode to generate hydrogen ions at least partially disposed within the ion exchange apparatus; and
eluting the target cation from the ion exchange apparatus.

22. The method of claim 21, wherein water splitting occurs primarily within the membrane apparatus.

23. The method of claim 21, wherein water electrolysis occurs primarily at the first electrode.

24. The method of claim 21, wherein the first electrode is a cathode.

25. The method of claim 21, wherein the membrane apparatus is a plurality of membrane apparatuses.

26. The method of claim 21, wherein the target cation comprises a lithium cation.

27. The method of claim 21, wherein the applied voltage is less than about 3 V.
